(19) United States
(12) Patent Application Publication
(10) Pub. No.: US 2014/0244425 A1
(43) Pub. Date: Aug. 28, 2014

(54) SYSTEM AND METHOD FOR PRESENTING AND FACILITATING ONLINE TRANSACTIONS OF APPAREL AND OTHER GOODS

(71) Applicant: DailyLook, Inc., Los Angeles, CA (US)

(72) Inventor: Brian Ree, Los Angeles, CA (US)

(21) Appl. No.: 14/231,462

(22) Filed: Mar. 31, 2014

Related U.S. Application Data
(63) Continuation of application No. 13/776,196, filed on Feb. 25, 2013.

(51) Int. Cl. G06Q 30/06

(52) U.S. Cl. CPC G06Q 30/0643; G06Q 30/0633
USPC 705/26.5; 705/26.8

(57) ABSTRACT

Techniques are disclosed for presenting and facilitating web-based commercial transactions. In some embodiments, the method includes displaying a first interface that includes: (a) a fashion look, the fashion look including a plurality of components which together represent the fashion look, and (b) a selectable link which, upon selection by a customer, directs the customer to a second interface. The method further includes, upon the customer selecting the selectable link, displaying the second interface including a plurality of fields. Each of the fields is configured to enable the customer to purchase a corresponding component from the plurality of components without navigating away from the second interface.

### CROSS-REFERENCE TO RELATED APPLICATIONS

This application is a continuation application of U.S. patent application Ser. No. 13/776,196, titled “SYSTEM AND METHOD FOR PRESENTING AND FACILITATING ONLINE TRANSACTIONS OF APPAREL AND OTHER GOODS,” filed on Feb. 25, 2013 (Attorney Docket No. 88612-8001.US01), the entire content of which is expressly incorporated by reference herein.

### TECHNICAL FIELD

The present invention generally relates to systems and methods for electronic commerce, and specifically to the presentation and facilitation interfaces for online transactions of apparel and other goods.

### BACKGROUND

Electronic commerce (“e-commerce”) has become an increasingly popular means of buying and selling commercial products such as apparel or fashion clothing. The pervasiveness of modern computer networks (e.g., the Internet) allow easy access for a customer user to browse for, compare, and purchase different products from one or more merchants at a time and location of the user's own preference. In the field of clothing sales, many retailers host websites having a home or directory page, which has links that allow the user to enter an individual page for a particular product. It is also typical for the retailers to categorize products into groups and/or subgroups by their particular audiences (e.g., men or women, tall or petite, etc.), by their types (e.g., shirts, polo shirts, outerwear, pants, shoes, bags, accessories, etc.), or perhaps by their designers.

However, conventional websites require the customer user to leave his or her currently browsing page and enter a separate page in order to purchase each individual product that the customer desires. This repetitive entering and exiting from one page to another consumes extra time and effort, thereby negatively affecting the customer user's shopping experience.

### SUMMARY OF THE DESCRIPTION

In a first aspect, a method for facilitating web-based commercial transactions is disclosed. The method includes locating a primary and a secondary interfaces. The primary interface includes at least a first button that enables a user to select for entering the secondary interface. The method further includes displaying a first look on the primary interface to the user. The first look includes a plurality of components which together represent the first look. The method further includes, upon the user selecting the first button, presenting the secondary interface comprising a plurality of subpages, wherein each subpage enables the user to purchase a corresponding component. In one or more examples, the secondary interface may include a plurality of tabs, and each tab corresponds to a subpage. The plurality of tabs may be selectable by the user to switch from one subpage to another subpage without navigating away from the secondary interface.

In some other aspects, the embodiments disclosed herein include a system for facilitating web-based commercial transactions, and a non-transitory computer-readable medium for the same. The system includes a processor and a memory coupled to the processor. The memory stores a plurality of instructions which, when executed by the processor, cause the processor to locate a primary and a secondary interfaces. The primary interface includes at least a first button that enables a user to select for entering the secondary interface. The instructions also cause the processor to display a first look on the primary interface to the user, the first look including a plurality of components which together represent the first look. Upon the user selecting the first button, the processor is to present the secondary interface comprising a plurality of subpages. Each subpage enables the user to purchase a corresponding component.

### BRIEF DESCRIPTION OF DRAWINGS

The present embodiments are illustrated by way of example and are not intended to be limited by the figures of the accompanying drawings. In the drawings:

FIG. 1 illustrates a representative computer network environment within which some embodiments may be implemented;

FIG. 2 illustrates a primary interface that presents and facilitates online commercial transactions in accordance with some embodiments;

FIGS. 3A and 3B illustrate a secondary interface for online commercial transactions in accordance with some embodiments; and

FIG. 4 illustrates a method for presenting and facilitating online transactions of goods in accordance with some embodiments.

The same reference numbers and any acronyms identify elements or acts with the same or similar structure or functionality throughout the drawings and specification for ease of understanding and convenience.

### DETAILED DESCRIPTION

Techniques are disclosed for presenting and facilitating web-based commercial transactions. In some embodiments, the method includes locating a primary and a secondary interfaces, wherein the primary interface includes at least a first button that enables a user to select for entering the secondary interface, displaying a first look on the primary interface to the user, wherein the first look includes a plurality of components which together represent the first look, and, upon the user selecting the first button, presenting the secondary interface comprising a plurality of subpages, wherein each subpage enables the user to purchase a corresponding component. In some embodiments, the secondary interface includes a plurality of tabs, each tab corresponding to a subpage, and wherein the plurality of tabs are selectable by the user to switch from one subpage to another subpage without navigating away from the secondary interface. The embodiments provided herein alleviates the burdensome and repetitive navigation among different product webpages during online shopping, thereby facilitating a better user experience.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known methods, procedures, structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

Conventional e-commerce websites require the customer user to navigate from one product page to another in order to browse, compare and purchase each individual product. This consumes extra time and effort, thereby negatively affecting the customer user's shopping experience, and it is particular the case in the apparel and fashion market. As previously mentioned, a typical retailer in such field has separate categories (e.g., tops, bottoms, shoes, bags, accessories, etc.) for each individual product, and generally the retailer hosts one or more categorical pages (e.g., under a main homepage) to list out items (or products) that belong to a particular category. Therefore, a commonly seen attempt to alleviate the aforementioned problems is the so-called “quick view” model. The quick view model may allow the customer to click on one categorical page and open, for example, a “pop-up” page to view, select attributes, and add to cart of an individual item. Indeed, many retailers have adopted this technique to allow the customers to quickly view an individual item without leaving the page that he or she is currently browsing; however, this technique is best suitable when the retailer focuses on selling and merchandising individual products, or when the customer is merely looking for purchasing an individual item.

Instead of individual products, there is an emerging market in the fashion industry which aims to sell an entire curated “look” that is created professionally by a fashion designer. A designer “look” generally includes one or more items (or components) from multiple categories. For example, a look may have many components, which may include a top, a bottom, a pair of shoes, a bag, and accessories, and each component of the look is predetermined by the designer so that the look is generally more complete and fashionable than a layman customer's selection.

Typically, such merchants would simply create a “looks” or “lookbook” category under the main homepage, and when the customer selects a look, the resulting page would show items from the selected look on the same web page, but the shown items are merely product links which link to another page on the merchant's website. Whether it is a conventional webpage or the above-discussed “quick view” page, current techniques do not avoid the repetitive entering and exiting each individual product's page which still makes the entire shopping experience less than ideal. Accordingly, the embodiments disclosed herein provide improved techniques to facilitate a better user experience and to alleviate the aforementioned burden in online shopping.

System Overview

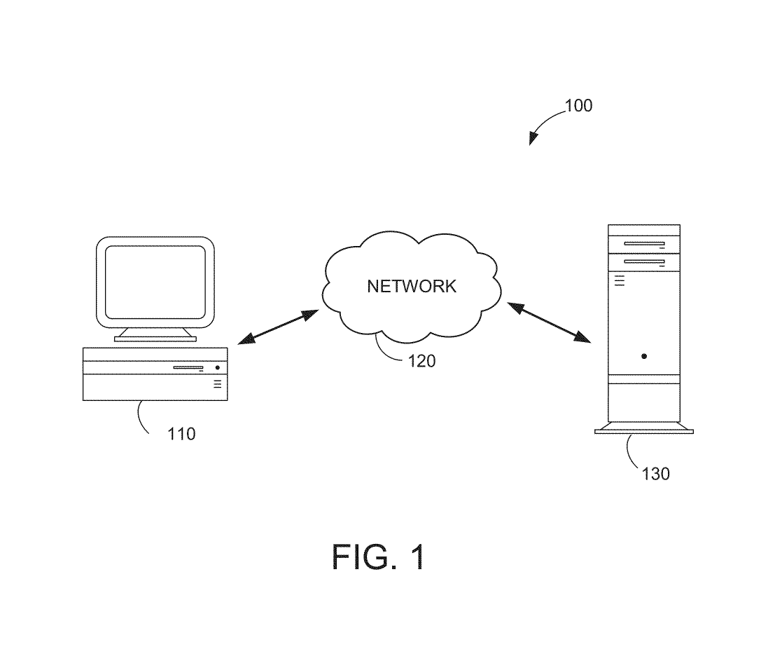

FIG. 1 illustrates a representative computer network environment 100 within which some embodiments may be implemented. The environment 100 includes a client 110, a network 120, and a server 130. The client 110 and server 130 are coupled in communication for data transmission over the network 120. For example, the components may be connected via a twisted pair cabling network, a coax cable network, a telephone network, or any suitable type of connection network. In some embodiments, the network 120 may be wireless. The technologies supporting the communications between the client 110 and server 130 may include Ethernet and/or other suitable types of area network technologies. One of ordinary skill in the art will understand that the components of FIG. 1 are just one implementation of the computer network environment within which present embodiments may be implemented, and the various alternative embodiments are within the scope of the present embodiments. For example, the network 120 may include intervening devices (e.g., switches, routers, hubs, etc.) in the network 120. In some examples, the network 120 comprises the Internet.

The server 130 may be one or more server computers or work stations that are employed by a merchant for hosting websites that function as a channel to customer users for browsing products and placing purchase orders. The server 130 typically includes at least one processor and a memory, and may be further connected to one or more computers (not shown in FIG. 1 for simplicity) that manage inventory, logistics and/or other commercial functions via the network 120. The client 110, which may be used by a customer user to communicate with the server 130 in performing the purchases (e.g., through the hosted websites), may include a laptop, a tablet, a personal computer, a personal digital assistant (“PDA”), a smart phone, and the like. The client 110 typically includes a display 115, and may include suitable input devices (not shown for simplicity) such as a keyboard, a mouse, or a touchpad. In some embodiments, the display 115 may be a touch-sensitive screen that includes input functionalities.

The embodiments disclosed herein recognize that existing techniques require the user to shop across many different individual product pages on the site regardless of whether the products are presented individually or by groups (e.g., looks). As such, a method and a system that generate a primary and a secondary interfaces which include a “multi-tabbed shopping” model for sales of looks are disclosed to improve the online shopping experience by reducing the effort of entering and existing different product pages individually. The shopping model may be populated over the secondary interface, and allows you to view, select attributes (e.g., color, size, quantity), and select for purchase (or “add to cart”) of multiple items (or components) without changing or refreshing the screen. For instance, the tabbed shopping model may load one or more of all the items, their corresponding images, and their product data all onto the secondary interface upon an activation (e.g., a click) of a particular link on the primary interface. Each tab may contain the product data of one item so that all the items on the secondary interface combined may be exactly the items that belong to the look selected on the primary interface.

More specifically, according to some embodiments, when the customer user enters (via the client 110 and the network 120) the merchant's website hosted on the server 130 and selects a look (e.g., under a categorical page for looks, or simply on the merchant's homepage), the server 130 automatically locates the primary and the secondary interfaces, and displays the selected look on the primary interface to the user (e.g., via display 115). As is described in more details below, the primary interface that is presented by the server 120 includes at least a first button that enables the user to select for entering the secondary interface. The first look includes a plurality of components which together represent the first look, and upon the user selecting the first button, the server 130 presents the secondary interface comprising a plurality of subpages to client 110, with each subpage being capable of enabling the user to purchase a corresponding component. In one or more implementations, the secondary interface may be populated with each and every subpage for all the components that together complete the selected look.

Notably, the locating the primary and secondary interfaces need not be simultaneous. According to one or more embodiments, the locating of the primary and secondary interfaces may take place sequentially or with a suitable scheduling, and may occur during a startup phase and/or during normal operations of the server 130. In one embodiment, the locating of the second interface takes place after the user selects the first button.

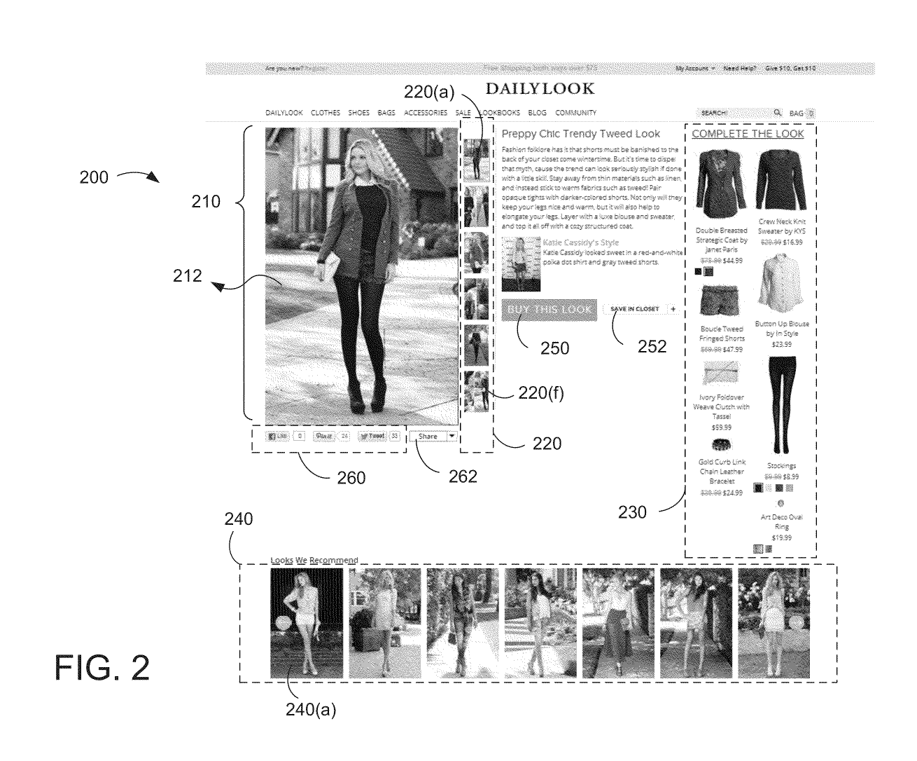

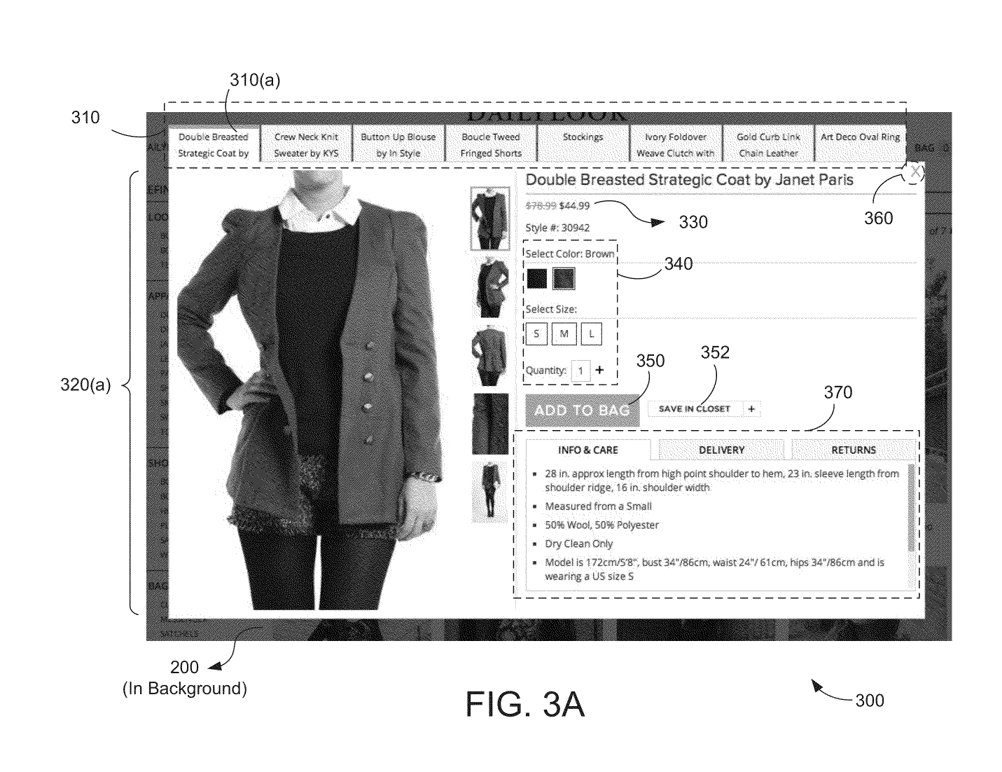

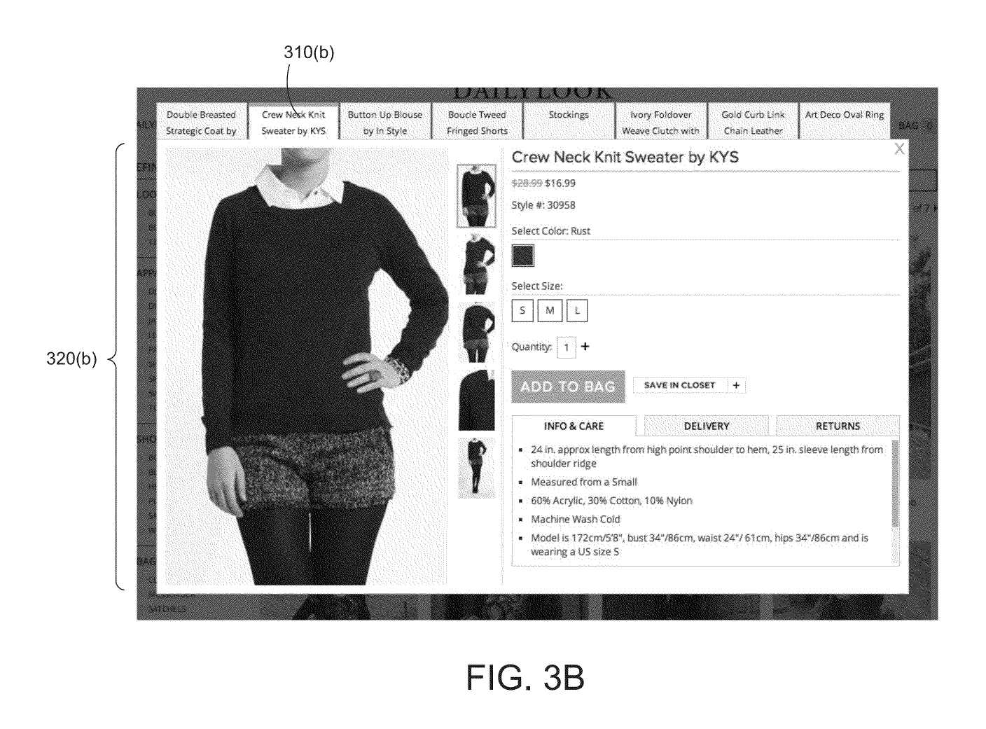

Further, in some embodiments, the secondary interface that is presented by the server 130 includes a plurality of tabs, and each tab corresponds to a subpage. The plurality of tabs are selectable by the user to switch from one subpage to another subpage without navigating away from the secondary interface. The embodiments, when implemented in the computer network environment 100, facilitate a better user experience and alleviate the burdens in navigating among different product webpages during online shopping. More details of implementing the primary and the secondary interfaces are described with respect to FIGS. 2, 3A and 3B below.

The Primary Interface

FIG. 2 illustrates a primary interface 200 that presents and facilitates online commercial transactions of a look 212 in accordance with some embodiments. The look 212 includes a plurality of components or items which together represent the look 212. The primary interface 200 may include a predetermined section 210, a thumbnail view section 220, a miniature component section 230, a look recommendation section 240, and a Buy This Look (“BTL”) button 250. Some implementations provide that the primary interface 200 also includes a social media section 260. The predetermined section 210 may be a predominant portion on the primary interface 200 for displaying the look 212.

According to some embodiments, the look 212 includes more than one views or perspectives, and when the interface 200 is first displayed to the customer, a predetermined view of the look 212 may be rendered onto the predetermined section 210 of the interface 200 for the customer to perceive. The thumbnail view section 220 may include a plurality of thumbnail views (e.g., thumbnail 220(f)) representing the other views that are not currently rendered onto the predetermined section 210. The plurality of thumbnail views inside the section 220 may each be selectable by the user to replace the view that is currently rendered onto the predetermined section 210 with a view that is represented by a thumbnail view that the user selects. It is noted that the view first rendered onto the section 210 (e.g., the predetermined view of the look 212) also has one thumbnail 220(a) that represents it in the thumbnail view section 220.

In some embodiments, the miniature component section 230 may be included in the primary interface 200 and may provide those above-discussed conventional functionalities such as entering an individual page for a component or generating a “pop-up” page of an individual component. Specifically, the miniature component section 230 includes a plurality of miniatures representing the plurality of components of the first look, and each miniature is selectable by the user to enter (or “pop-up”) a corresponding subpage of the selected component.

Additionally or alternatively, the primary interface 200 may also include the look recommendation section 240 for displaying and recommending other available looks (e.g., look 240(a)) that are of similar styles or share similar characteristics with the look 212. In this additional or alternative embodiment, the looks may each include a plurality of tags. The tags for a particular look may be indications or labels indicative of the characteristics, style, or other applicable traits of the look. For example, the tags may include “summer,” “bright,” “spotty,” “nightlife,” “semi-formal,” “military,” or may even be a celebrity's name if such celebrity endorses or has worn the look. In some examples, the server 130 may automatically select the other available looks based on a similarity of the tags between a candidate look and the look that is currently displayed (e.g., the look 212) on the primary interface 200. Depending on the implementation, the recommended looks (e.g., look 240(a)) may each occupy a smaller display area or less predominant section on the primary interface 200 than the look 212.

Optionally, the social media section 260 includes a variety of quick buttons for the customer user to activate and interact with his or her social circle via one or more third party social network websites. For example, one of the variety of quick buttons may include a “like” button or a “tweet” button, and when the customer user clicks on the like button, the server 130 automatically communicates with one or more third party application programming interfaces (“APIs”) over the network 120 so that the user may publish a message or a post regarding the look on his or her own social media page. In one or more examples, the post includes a scaled-down size view of the look 212, an abbreviated description of the look 212, and a link that links to the primary interface 200. Further, a drop down menu 262 may be implemented to be near the social media section 260 for the customer user to select additional means (e.g., email) of sharing the look 212 with his or her social circle.

The BTL button 250 may be an action button, a link, or the like, that, upon selected or activated by the user, causes the server 130 to present the secondary interface. More specifically, when the user selects the BTL button 250, the secondary interface presented by the server 130 includes a plurality of subpages, and each subpage enables the customer user to purchase an item or a component that corresponds to and is displayed on the subpage. In one implementation, the plurality of subpages enable the customer to purchase all the components that belong to the look 212. The implementation details of the secondary interface is provided below with regard to FIGS. 3A and 3B.

As an option, a “Save in Closet” button 252 may be displayed near the BTL button 250 for the user to save the look 212 in a temporary repository for future reference or a later purchase.

The Secondary Interface

FIGS. 3A and 3B illustrate a secondary interface 300 for online commercial transactions in accordance with some embodiments. The secondary interface 300 includes a tab section 310, which includes a plurality of tabs (e.g., tabs 310(a) and 310(b) in FIGS. 3A and 3B, respectively). The secondary interface 300 also includes a plurality of subpages 320. According to the embodiments disclosed herein, each tab corresponds to a subpage, and each subpage enables the user to purchase an item or a component that belongs to the look 212. Specifically, each tab may include a short description of its corresponding component such as “Double Breasted Strategic Coat by ABC,” or “Crew Neck Knit Sweater by DEF”.

Tabs

The plurality of tabs in the tab section 310 are each selectable by the user to switch from one subpage to another subpage without navigating away from the second interface 300. Further, when a respective tab is selected, the subpage that corresponds to the selected tab may be rendered by the server 130 onto the secondary interface 300 so that the subpage's content occupies a majority portion of the secondary interface 300. The majority portion is more than 50% of the total display area available on the second interface 300. When one subpage is selected and rendered so as to occupy the majority portion of the second interface 300, contents of all other subpages that are not being selected are concealed from a view of the user; however, none of those tabs for the subpages are concealed from the view of the user. In some embodiments, the tab section 310 may be always viewable to the user as long as the second interface 300 is being presented.

Take tabs 310(a) and 310(b) as an example. Illustrated in FIG. 3A is the secondary interface 300 with tab 310(a) being selected and its corresponding subpage 320(a) being rendered so that the subpage 320(a) occupies the majority portion of the interface 300. All other tabs, including tab 310(b), are currently not selected, and therefore their corresponding subpages (e.g., subpage 320(b)) are concealed. However, the tab section 310 remains viewable in its entirety so that the user may select any tab and switch among different subpages if the user so desires. As shown in FIG. 3B, if the user selects tab 310(b) (e.g., via a mouse click), then its corresponding subpage 320(b) takes over the display area where the subpage 320(a) is rendered, and the subpage 320(a) becomes concealed, so that the user may see the content of the subpage 320(b). Notably, in FIG. 3B, even with its subpage 320(a) concealed, the lab 310(a) is still viewable and selectable by the user. In this way, the user may select the plurality of tabs in order to switch from one subpage to another subpage without navigating away from the second interface 300.

In some alternative embodiments, the secondary interface 300 includes a slider bar (not shown for simplicity) operable by the user to switch among different subpages without navigating away from the secondary interface 300. More specifically, the user may scroll left and right (or up and down) to browse across different subpages.

Subpages

According to one or more embodiments, each subpage (e.g., subpage 320(a)) includes a plurality of elements including, for example, a price display 330, an attribute selection section 340, a purchase button 350, and an exit button 360.

The price display 330 indicates a purchase price for the component that is displayed on the subpage 320(a). The server 130 may further be configured to indicate a discounted price on the price display 330 according to one or more discount policies set by the merchant. In one embodiment, the server 130 is to apply a discount to a plurality of purchase prices of components when a predetermined number of components of the same look are selected for purchase by the customer. For example, if the predetermined number is three, then if the customer has already put two items or components of the look 212 in his or her list of purchase (e.g., “shopping cart”), then the server 130 may indicate a discounted price on the price display 300 to entice the customer to purchase a third item of the look 212.

The attribute selection section 340 allows the customer user to customize his or her order before the purchase. For example, the customer may choose the available color, size, and quantity of the particular component. The purchase button 350 puts the component on the subpage into a list of purchase, where the customer may review the final order, give the shipping and billing information, and place the order. As an option, a “Save in Closet” button 352 may be displayed near the purchase button 350 for the user to save the component in a temporary repository for future reference or a later purchase.

The exit button 360 allows the user to leave the secondary interface 300 and go back to the primary interface 200. Of course, the exit button 360 is merely exemplary, as a person having ordinary skill in the art will understand that other equivalents may be implemented with the embodiments disclosed herein as well. For example, a mouse click outside the secondary interface 300 (e.g., on the primary interface 200, which is illustrated in FIG. 3 as the darkened portion of in the background) or a press on the “Escape” key of the customer's keyboard may allow the customer to leave the secondary interface 300 and go back to the primary interface 200.

In some embodiments, the subpage 320(a) also includes a detailed description section 370 of its corresponding component. In some embodiments, the plurality of elements (e.g., elements 330-360) of a subpage are arranged and configured so that they may be presented on the secondary interface 300 in their entirety, without the need of vertical scrolling in a browser or screen.

Methodology

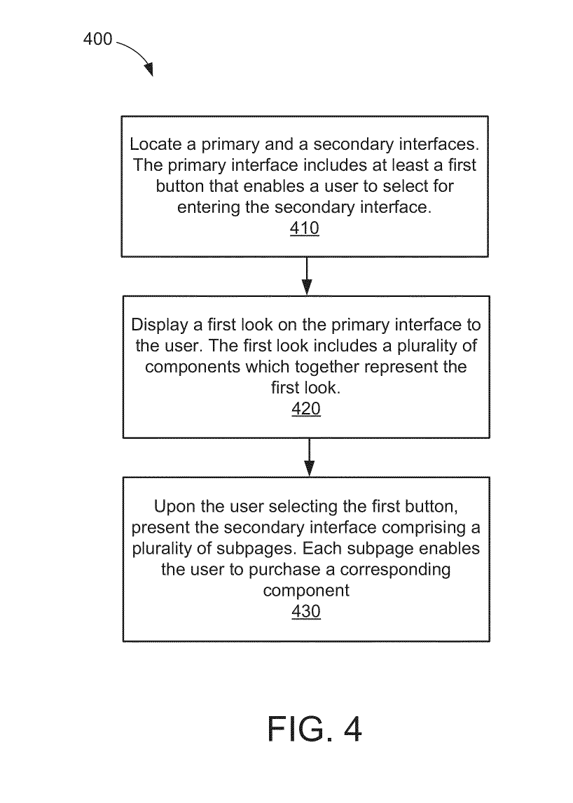

FIG. 4 illustrates a method 400 for presenting and facilitating online transactions of goods in accordance with some embodiments. The method 400 may be performed, for example, in the network environment 100 by the server 130 (FIG. 1).

The server 130 locates (410) a primary interface (e.g., interface 200, FIG. 2) and a secondary interface (e.g., interface 300, FIGS. 3A-3B). The primary interface includes at least a first button (e.g., BTL button 250) that enables a user (e.g., using the client 110, FIG. 1) to select for entering the secondary interface. When the client 110 selects to enter the primary interface, the server 130 displays (420) a first look (e.g., look 212, FIG. 2) on the primary interface to the user. The first look includes a plurality of components which together represent the first look.

Next, when the user selects the first button, the server 130 presents (430) the secondary interface. The secondary interface includes a plurality of subpages (e.g., subpage 320(a)), and each subpage enables the user to purchase (e.g., via purchase button 350) a corresponding component. In some embodiments, the secondary interface displayed by the server 130 includes a plurality of tabs, and each tab corresponds to a subpage. The plurality of tabs are selectable by the user to switch from one subpage to another subpage without navigating away from the secondary interface.

The embodiments provided herein alleviates the burdensome and repetitive navigation among different product webpages during online shopping, thereby facilitating a better user experience.

Conclusion

In the foregoing specification, the examples have been described with reference to specific exemplary implementations thereof. It will, however, be evident that various modifications and changes may be made thereto without departing from the broader scope of the disclosure. The specification and drawings are, accordingly, to be regarded in an illustrative sense rather than a restrictive sense.

What is claimed is:

1. A method for facilitating web-based commercial transactions, the method comprising:
displaying a first interface that includes: (a) a fashion look, the fashion look including a plurality of components which together represent the fashion look, and (b) a selectable link which, upon selection by a customer, directs the customer to a second interface; and
upon the customer selecting the selectable link, displaying the second interface including a plurality of fields,
wherein each of the fields is configured to enable the customer to purchase a corresponding component from the plurality of components without navigating away from the second interface.

2. The method of claim 1, wherein each of the fields includes a picture of its corresponding component.

3. The method of claim 1, wherein at least some of the plurality of fields are simultaneously displayed on the second interface.

4. The method of claim 1, wherein each of the fields is a selectable item, and the method further comprises:
upon the customer selecting a field, rendering the field onto the secondary interface so that content of the selected field occupies a majority portion of the secondary interface.

5. The method of claim 4, wherein each of the fields includes a picture of its corresponding component, and wherein each of the fields is selectable by clicking on each field's picture.

6. The method of claim 1, wherein each of the fields enables the customer to purchase the corresponding item by providing a button for the customer to place the corresponding item into a transaction buffer.

7. The method of claim 1, wherein each of the fields enables the customer to purchase the corresponding item by providing a checkbox for the customer to select the corresponding item into a transaction buffer.

8. The method of claim 1, wherein each of the fields enables the customer to purchase the corresponding item by providing a button for the customer to save the corresponding item into a queue for a later transaction.

9. The method of claim 1, wherein each of the fields is further configured to enable the customer to adjust one or more customizable options associated with the corresponding component before purchasing.

10. The method of claim 9, wherein the customizable options comprise color, size, and quantity.

11. The method of claim 1, wherein the selectable link is displayed as a clickable button which is designated for purchasing the fashion look.

12. The method of claim 1, wherein the selectable link is associated with a picture of a component.

13. The method of claim 1, wherein displaying the second interface comprises overlaying the second interface on the first interface with the first interface serving as a background.

14. The method of claim 13, wherein the background is overlaid as translucent or transparent.

15. A system for facilitating web-based commercial transactions, the system comprising:
a processor;
a communication module; and
a memory coupled to the processor and storing a plurality of instructions which, when executed by the processor, configure the processor to transmit, via the communication module, codes to a web browser of a customer so as to cause the web browser to:
display a first interface that includes: (a) a fashion look, the fashion look including a plurality of components which together represent the fashion look, and (b) a selectable link which, upon selection by the customer, directs the customer to a second interface; and
upon the customer selecting the selectable link, display the second interface including a plurality of fields,
wherein each of the fields is configured to enable the customer to purchase a corresponding component from the plurality of components without navigating away from the second interface.

16. The system of claim 15, wherein each of the fields includes a picture of its corresponding component.

17. The system of claim 15, wherein at least some of the plurality of fields are simultaneously displayed on the second interface.

18. The system of claim 15, wherein each of the fields is a selectable item, and the web browser of the customer is further caused by the codes to:
upon the customer selecting a field, render the field onto the secondary interface so that content of the selected field occupies a majority portion of the secondary interface.

19. The system of claim 18, wherein each of the fields includes a picture of its corresponding component, and wherein each of the fields is selectable by the customer clicking on each field's picture.

20. The system of claim 15, wherein each of the fields enables the customer to purchase the corresponding item by providing a button for the customer to place the corresponding item into a transaction buffer.

21. The system of claim 15, wherein each of the fields enables the customer to purchase the corresponding item by providing a checkbox for the customer to select the corresponding item into a transaction buffer.

22. The system of claim 15, wherein each of the fields enables the customer to purchase the corresponding item by providing a button for the customer to save the corresponding item into a queue for a later transaction.

23. The system of claim 15, wherein each of the fields is further configured to enable the customer to adjust one or more customizable options associated with the corresponding component before purchasing.

24. The system of claim 23, wherein the customizable options comprise color, size, and quantity.

25. The system of claim 15, wherein the selectable link is displayed as a clickable button which is designated for purchasing the fashion look.

26. The system of claim 15, wherein the selectable link is associated with a picture of a component.

27. The system of claim 15, wherein the web browser of the customer is further caused by the codes to, in displaying the second interface: overlay the second interface on the first interface with the first interface serving as a background.

28. The system of claim 27, wherein the background is overlaid as translucent or transparent.
